(19) United States
(12) Patent Application Publication
(10) Pub. No.: US 2014/0078726 A1
(43) Pub. Date: Mar. 20, 2014

(54) LED Lens Assembly

(71) Applicant: Chang Ching Tsai, Orlando, FL (US)

(72) Inventor: Chang Ching Tsai, Orlando, FL (US)

(73) Assignee: Dr. Chang Ching Tsai, Orlando, FL (US)

(21) Appl. No.: 13/620,755

(22) Filed: Sep. 15, 2012

(51) Int. Cl. F21V 5/04; F21V 29/00; F21V 3/02

(52) U.S. Cl. 362/218; 362/235; 362/326; 362/335

(57) ABSTRACT

A LED lens assembly comprises a longitudinal rotationally symmetric inner surface contact to at least one LED and a longitudinal rotationally symmetric exterior surface exposure to the air. The half of the longitudinal cross section of the exterior surface constitutes at least three sections. One primary section bounds part of light by longitudinal total internal reflection, one secondary section reflects part of light by transverse total internal reflection and one tertiary section spreads light accordingly. The shape of each section includes straight or curved lines. The surface of each section includes micro structure of a smooth surface, a diffusive surface, a grating surface, a grooving surface, a surface of random gratings, an irregular grooving surface, a random scattering surface, or a surface of photonics crystal. The LED lens assembly further comprises one concave lens on top of the exterior surface.

### BACKGROUND

The description relates to a LED lens assembly for LED light broadening.

In some embodiments, the major distributions of light intensities emitting from LEDs (light emitting diode) are limited to a cone region in free space. This property of limited illumination of LEDs is not suitable for general lighting applications.

To reach omni-directional illumination with LEDs, in one embodiment of LED light bulb, several approaches are proposed. One common method is to place, at least two, LEDs oriented in different directions to cover larger illumination area. Another method employs optical lens to redirect or spread the light from LEDs to wider angles. There are disadvantages in these two methods. The method of placing several LEDs in different orientations causes more manufacturing issues and heat dissipation problems, which increases the manufacturing cost. On the other hand, in most of lens-design arts, the light from LEDs can spin over a wide region, but lose the uniformity. For direct replacement of conventional light bulbs, the LEDs irradiance requires both broadness and uniformity that can be used in the existing lighting fixtures.

In the present invention, a new LED lens assembly featuring a particular configuration that enables broadening and smoothing the light distributions is proposed. A LED light, bulb with the innovative LED lens assembly in this invention can be easily manufactured and ready for general lighting applications.

### SUMMARY

In one respect, in general, the light emitting from LEDs is reflected and refracted through a LED lens assembly into free space. The light distributions in free space are uniformly broadened by a particular shape of the LED lens assembly through proper internal reflections and refractions.

In one aspect, a LED light assembly is disclosed. The LED lens assembly for broadening LED light distribution includes an inner surface for receiving a plurality of rays emitting from at least one LED chip, and an exterior surface for confining and redirecting the plurality of rays received by the inner surface. The inner surface is in contact with at least one LIED chip and is rotational symmetric about one longitudinal axis. The exterior surface is rotationally symmetric about the longitudinal axis, coaxial with the inner surface.

In one embodiment, the inner surface covers and touches the top surface of the LED chip closely.

In one embodiment, a longitudinal cross-section of the exterior surface containing the longitudinal axis of the rotationally symmetric exterior surface includes a mushroom structure, a Y structure, a tree structure, a tower structure, a pillar structure, a tube structure, or a sword structure.

In one embodiment, a half of the longitudinal cross-section of the rotationally symmetric exterior surface includes at least three sections to constitute the periphery of the half of the longitudinal cross-section. The at least three sections include at least one primary section to bound a portion of the rays received by the inner surface from the LED chip by total internal reflection with a plurality of rays propagating parallel to the longitudinal axis inside the lens assembly; at least one secondary section to receive the bounded longitudinally propagating rays from the primary section to have total internal reflection with a plurality of rays propagating transverse to the longitudinal axis inside the lens assembly; and at least one tertiary section to receive a plurality of rays reflected from the secondary section and transmit a plurality of rays into the air.

In one embodiment, the primary section transmits laterally a portion of the rays received by the inner surface from the LED chip into the air.

In one embodiment, the secondary section transmits upwardly a portion of the bounded longitudinally propagating rays from the primary section into the air.

In one embodiment, a geometric shape of each of the three sections is selected front a group consisting of a straight line, a curve, an arc, a concave structure, and a convex structure.

In one embodiment, the exterior surface has at least one section, where total internal reflection occurs with light propagating in the direction transverse to the longitudinal axis.

In one embodiment, the exterior surface has at least one section, where outward transmission occurs with light propagating within an incident angle less than the critical angle of total internal reflection with respect to the section.

In one embodiment, the exterior surface has at least one section, wherein a regular structure is textured on the surface.

In one embodiment, the exterior surface has at least one section, wherein an irregular structure is textured on the surface

In one embodiment, the at least three sections includes at least one primary section to bound a portion of the rays received by the inner surface from the LED chip by total internal reflection with a plurality of rays propagating parallel to the longitudinal axis inside the lens assembly, at least one secondary section to receive the bounded longitudinally propagating rays from the primary section to have total internal reflection with a plurality of rays propagating transverse to the longitudinal axis inside the lens assembly, and at least one tertiary section to receive a plurality of rays reflected from the secondary section and transmit a plurality of rays into the air.

In one embodiment, the primary section transmits laterally a portion of the rays received by the inner surface from the LED chip into the air.

In one embodiment, the secondary section transmits upwardly a portion of the hounded longitudinally propagating rays from the primary section into the air.

In one embodiment, a geometric shape of each of the three sections is selected from a group consisting of a straight line, a curve, an arc, a concave structure, and a convex structure.

In one embodiment, an arctangent of a mathematical slope of each of the three sections is within a respective scope of: the primary section having a tangent line at each point of a geometric shape, with the arctangent of the slope of the tangent line in the range from 45 to 135 degree; the secondary section having a tangent line at each point of a geometric shape, with the arctangent of the slope of the tangent line in the range from 0 to 90 degree; and the tertiary section having a tangent line at each point of a geometric shape, with the arctangent of the slope of the tangent line in the range from 0 to 180 degree.

In one embodiment, each of the three sections has a micro structure that corresponds to at least one of a smooth surface, a diffusive surface, a grating surface, a grooving surface, a surface of random gratings, an irregular grooving surface, a random scattering surface, or a surface of photonics crystal.

In one embodiment, the LED lens assembly further includes a concave lens on top of the exterior surface. The additional concave lens can be placed on the top of the exterior surface to form a closed region between the exterior surface and the concave lens, wherein the index of refraction of the closed region is less than the index of refraction of the LED lens assembly.

In another aspect of the present invention, a LED light bulb is disclosed. The LED light bulb includes at least one LED chip, a lens assembly, a heat sink, and a transparent shell. The lens assembly includes an inner surface for receiving a plurality of rays emitting from the at least one LED chip, and an exterior surface for confining and redirecting the plurality of rays received by the inner surface. The inner surface is in contact with at least one LED chip and is rotational symmetric about one longitudinal axis. The exterior surface is rotationally symmetric about the longitudinal axis, coaxial with the inner surface. The exterior surface encloses the inner surface with one adjoined circular border line. The heat sink has the LED lens assembly mounted thereon. The transparent shell covers the heat sink.

In one embodiment, the longitudinal cross-section of the exterior surface containing the longitudinal axis of the rotationally symmetric exterior surface includes a mushroom structure, a Y structure, a tree structure, a tower structure, a pillar structure, a tube structure, or a sword structure.

In one embodiment, a half of the longitudinal cross-section of the rotationally symmetric exterior surface includes at least three sections to constitute the periphery of the half of the longitudinal cross-section. The at least three sections includes at least one primary section, at least one secondary section, and at least one tertiary section. The at least one primary section is to bound a portion of the rays received by the inner surface from the LED chip by total internal reflection with a plurality of rays propagating parallel to the longitudinal axis inside the LED lens assembly. The at least one secondary section is to receive the bounded longitudinally propagating rays from the primary section to have total internal reflection with a plurality of rays propagating transverse to the longitudinal axis inside the LED lens assembly. The at least one tertiary section is utilized to receive a plurality of rays reflected from the secondary section and transmit a plurality of rays into the air.

In further another aspect of the present invention, a LED tube lamp is disclosed. The LED tube lamp includes at least two LED chips, at least two LIED lens assemblies, a heat sink and a transparent shell. The at least two LED chips line in one row. Each LED chip is covered by one of the at least two LED lens assemblies. Each of the LED lens assemblies comprises an inner surface for receiving a plurality of rays emitting from one LED chip, and an exterior surface for confining and redirecting the plurality of rays received by the inner surface. The inner surface is in contact with one LED chip and is rotational symmetric about one longitudinal axis. The exterior surface is rotationally symmetric about the longitudinal axis, coaxial with the inner surface. The exterior surface encloses the inner surface with one adjoined circular border line. The heat sink has the LED chip and the LED lens assembly mounted thereon. The transparent shell covers the heat sink.

In further another aspect of the present invention, a LED round lamp is disclosed. The LED round lamp includes at least three LED chips, at least three LED lens assemblies, a heat sink and a transparent shell. The at least three LED chips line in one circle or ellipse. Each LED chip is covered by one of the at least three LED lens assemblies. Each of the at least three LED lens assemblies comprises an inner surface for receiving, a plurality of rays emitting from one LED chip, and an exterior surface for confining and redirecting the plurality of rays received by the inner surface. The inner surface is in contact with one LED chip and is rotational symmetric about one longitudinal axis. The exterior surface is rotationally symmetric about the longitudinal axis, coaxial with the inner surface. The exterior surface encloses the inner surface with one adjoined circular border line. The heat sink has the LED chip and the LED lens assembly mounted thereon. The transparent shell covers the heat sink.

Advantage of the present LED lens assembly is to provide wide angle illumination in free space with rather good uniformity. The configuration of the LED light bulb and light tube are simple and can be easily fabricated. Further objects and advantages of this invention will be apparent from the following detailed description with accompanied drawings.

### DESCRIPTION OF DRAWINGS

FIG. 1 shows a LED lens assembly according to a preferred embodiment of the present invention.)

FIGS. 2a to 2d are sectional views of the LED lens assembly in FIG. 1.

FIG. 3 is a sectional view of a LED lens assembly according to another preferred embodiment of the present invention.

FIG. 4a is a sectional view of a LED lens assembly according to further another preferred embodiment of the present invention.

FIG. 4b is a sectional view of a LED lens assembly according to farther another preferred embodiment of the invention.

FIG. 5 is a sectional view of a LED lens assembly according to further another preferred embodiment of the present invention.

FIG. 6 is a sectional view of a LED lens assembly according to further another preferred embodiment of the present invention.

FIG. 7a shows a LED lens assembly according to a preferred embodiment of the present invention.

FIG. 7b is a sectional view of the LED lens assembly in FIG. 7a.

FIG. 8 shows a LED light bulb with LED lens assembly according to a preferred embodiment of the present invention.

FIG. 9 shows a LED light bulb with LED lens assembly according to another preferred embodiment of the present invention.

FIG. 10 shows a LED tube lamp with LED lens assembly according to a preferred embodiment of the present invention.

FIG. 11 shows a LED round lamp with LED lens assembly according to a preferred embodiment of the present invention.

### DETAILED DESCRIPTION

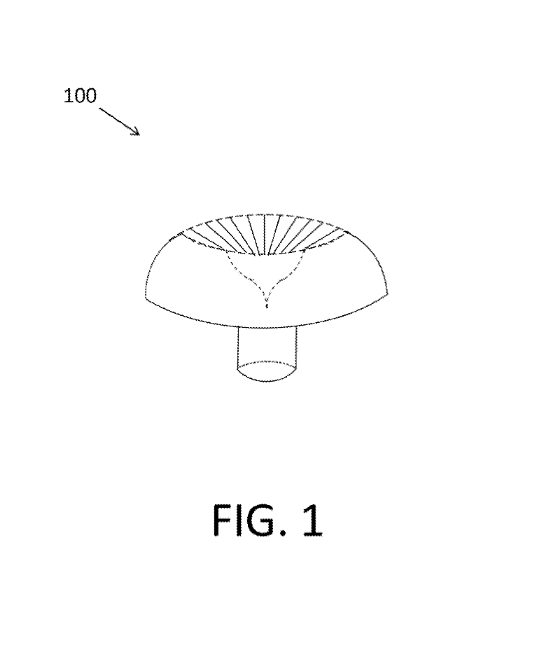

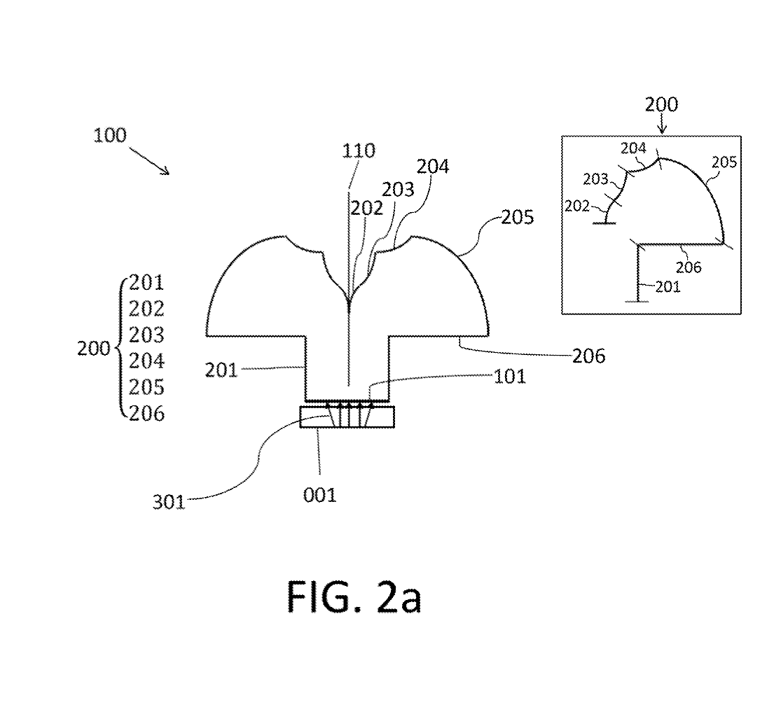

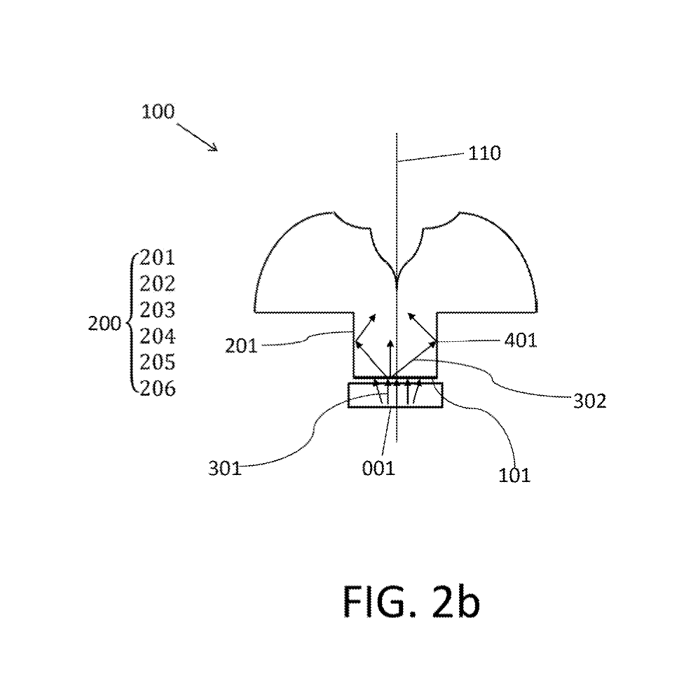

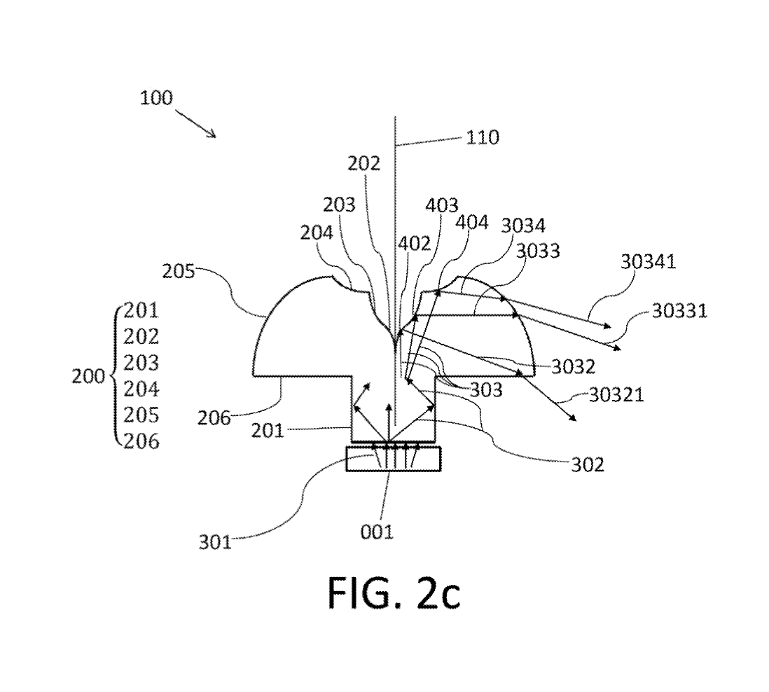

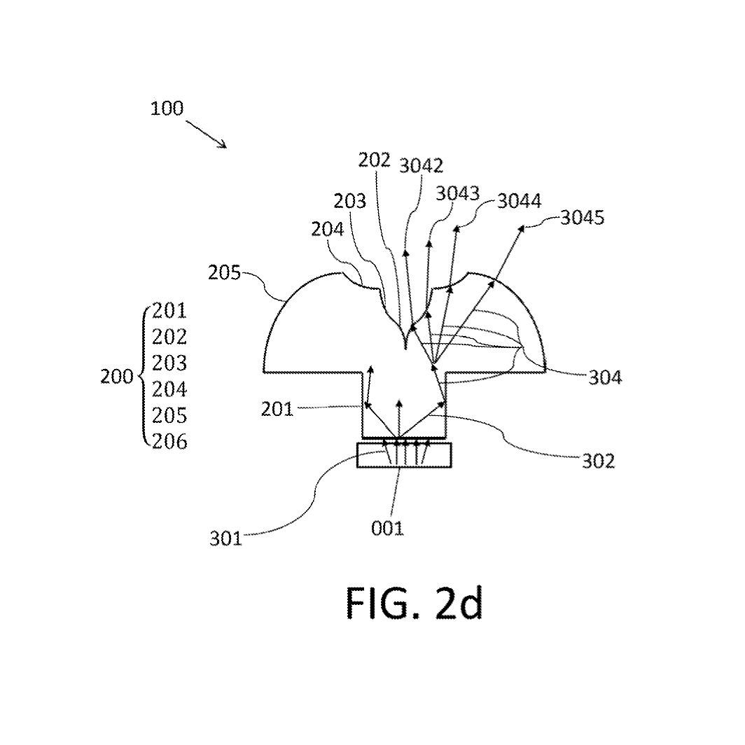

FIG. 1 shows a LED lens assembly 100 with wide angle of illumination according to one embodiment of the present invention. FIG. 2a is the sectional view of FIG. 1, wherein the LED lens assembly 100 receives and spreads the rays 301 emitting from LEDs 1 into free space. The LED lens assembly 100 includes an inner surface 101 and an exterior surface 200. The exterior surface 200 includes a primary section 201, secondary sections 202, 203, 204, and tertiary sections 205, 206 as shown in the upright window, which is rotationally symmetric about one longitudinal axis 110. Due to this symmetric property, figure illustration with half of the cross section of the exterior surface 200 will represent the whole configuration in the rest discussion of the entire description. As shown in FIG. 2b, the upward emitting rays 301 are received by inner surface 101 and become the transmission rays 302. Rays 302 propagate vertically and are bounded by the primary section 201 of the exterior surface 200, wherein total internal reflections 401 occurs that makes rays 302 propagate along the longitudinal axis 110. In FIG. 2c, part of rays 302, say ray 303, reaches and hits the secondary sections 202, 203, and 204 of exterior surface 200, where total internal reflections occur on points 402, 403 and 404 such that the reflected rays 3032, 3033 and 3034 propagate outwardly transverse to the longitudinal axis 110, pass through the tertiary sections 205, 206 and become transmission rays 30321, 30331 and 30341 in the air. In FIG. 2c, part of rays 302, say rays 304, reaches the secondary sections 202, 203, 204 and the tertiary section 205 of exterior surface 200 which directly refract and transmit rays 3042, 3043, 3044 and 3045 into the air, respectively. Through the above various reflections and refractions, the transmitting rays 30321, 30331, 30341, 3042, 3043, 3044 and 3045 in FIG. 2c and FIG. 2d constitute the widely distributed light in free space by the LED lens assembly 100 designed in the present invention.

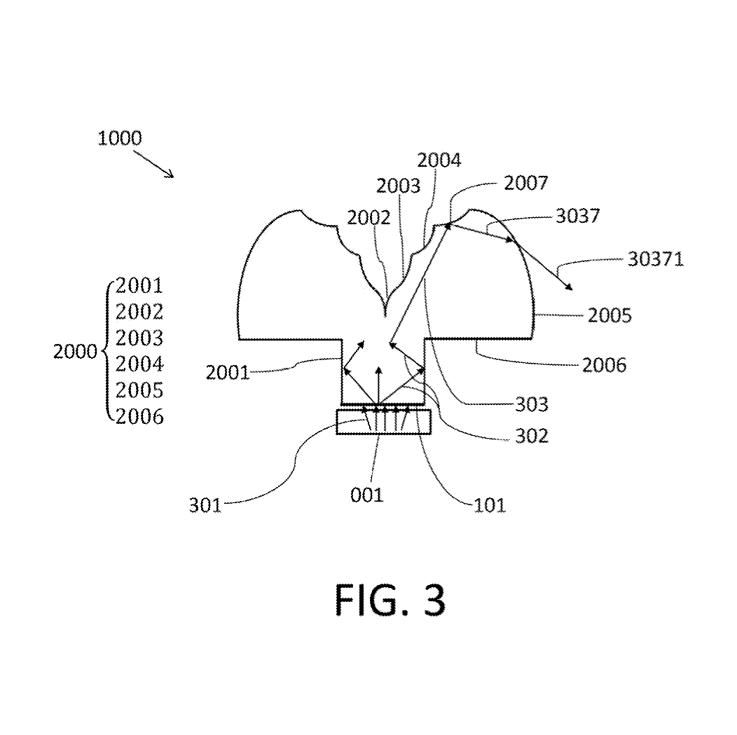

The degree of broadness of light distribution, not uniformity, can be decided by the amount of the transverse total internal reflections, for embodiment, the numbers of the reflection points, like 402, 403, and 404 on the exterior surface 200 of LED lens assembly 100 in FIG. 2c. FIG. 3 shows another embodiment of the present invention, similar to FIG. 2a, except with one additional secondary concave section 2007 on the exterior surface 2000 and different shapes of lens sections 2001, 2002, 2003, 2004, 2005, and 2006 in the LED lens assembly 1000. More rays 3037 are totally reflected transverse-downwardly inside the LED lens assembly 1000, which cause more rays 30371 transmitting out of the LED lens assembly 1001 downwardly such that the light distribution in free space is further broadened. The determination of light distribution in wider angles is based on the principle of how many secondary concave sections are designed on the exterior surface 2000, which decides how much light amount will be redistributed outwardly and downwardly in free space. Meanwhile, the particular shape of each concave section determines the uniformity.

The main spirit of present invention is according to three schemes performed by the primary, secondary, and tertiary sections of exterior surface 200 in FIG. 2a. First, as shown in FIG. 2a, the primary section 201 promotes the planar wave front LEDs rays 301 to curvier wave front rays 302 inside the exterior surface section 201 through longitudinal total internal reflection 401. Second, as shown in FIG. 2b, part of rays 302, rays 303, are redirected outwardly by transverse total internal reflection 402, 403, 404 on the secondary surface sections 202, 203, 204 and become rays 3032, 3033, 3034. Third, through various refractions, together by the secondary sections 202, 203, 204 shown in FIG. 2d to have output rays 3042, 3043, 3044; and by the tertiary sections 205, 206 shown in FIG. 2c to have output rays 30321, 30331, 30341 and 3045 respectively, the uniformity of the light distribution in the air can be greatly improved by all contributions from each section with a particular shape.

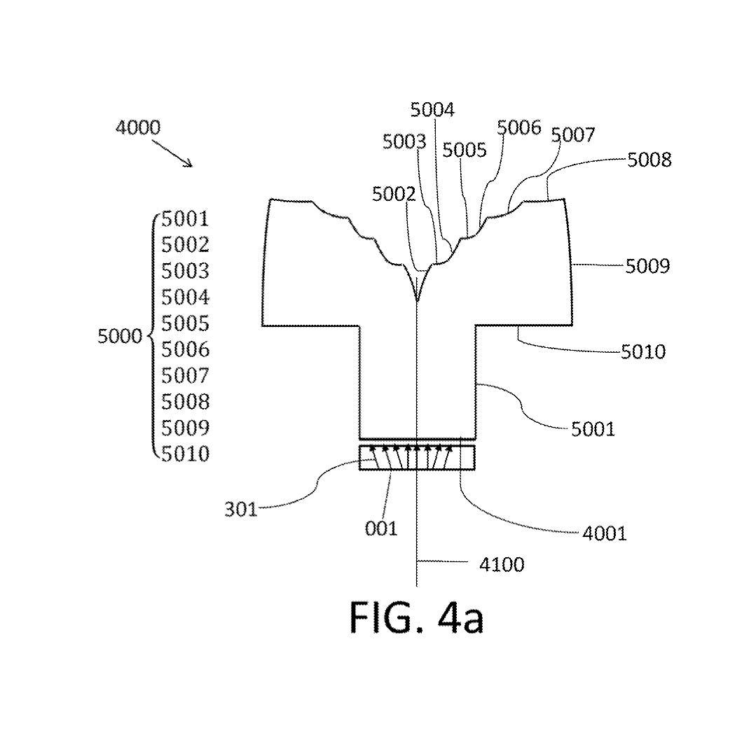

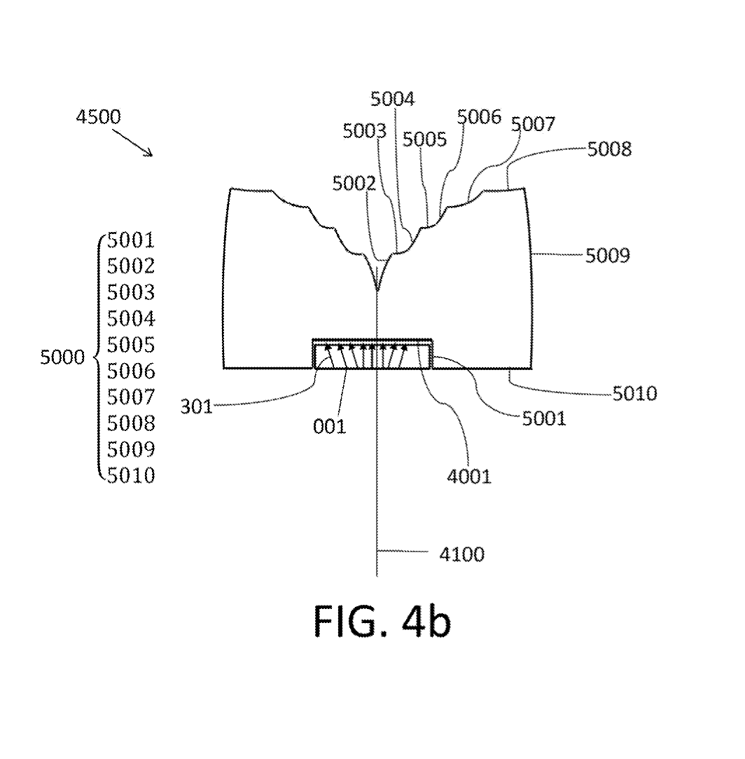

To achieve omni-directional illumination, one particular embodiment is illustrated in FIG. 4a. The lens 4000 includes one inner surface 4001 and one exterior surface 5000 which are rotationally symmetric about one axis 4100. Similar to the previous lens 100 in FIG. 2a and lens 1000 in FIG. 3, the exterior surface 5000 has primary section 5001, secondary sections, 5002, 5003, 5004, 5005, 5006, 5007, 5008, and tertiary sections 5009, 5010. The slopes of the tangent lines to all points on the boundaries of the secondary sections, 5002, 5003, 5004, 5005, 5006, 5007, 5008 in FIG. 4a all fall in the scope of 0 to 1. The design of such a shape of the lens 4000 is to match the light distribution diagram from incandescent lamp in free space as close as possible. FIG. 4b shows another embodiment of a lens structure very similar to FIG. 4a. In FIG. 4b. the lens 4500 has the inner surface 4001 and the primary section 5001 that embed the LED 001, which are different from those 4001 and 5001 in FIG. 4a. Another feature of lens 4500 in FIG. 4b is the tertiary section 5009 that extends down below the inner face 4001, which makes the lens 4500 encapsulate the whole LED 001 inside.

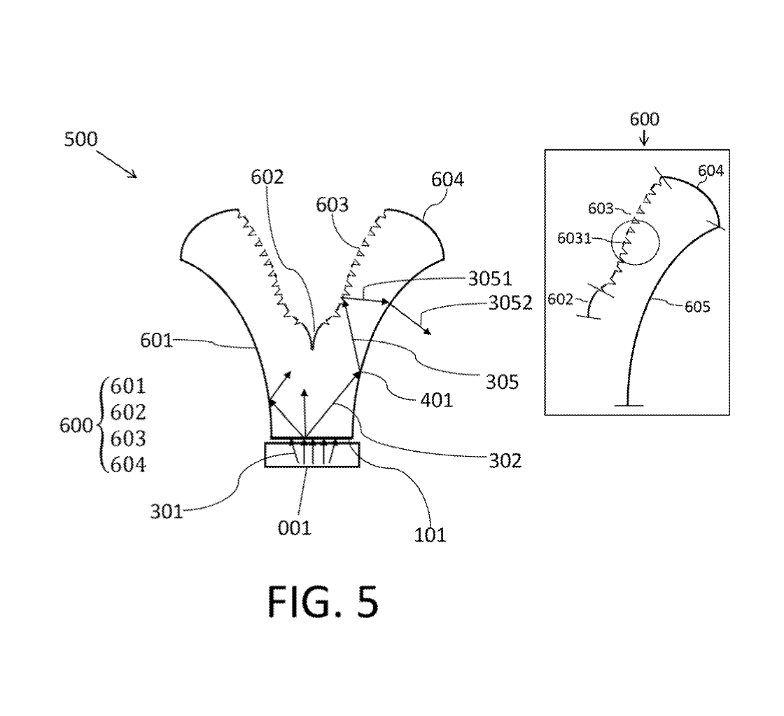

Another scheme to enhance the broadness of illumination is to add various textures on the various sections of the exterior surface 200 in FIG. 2a. FIG. 5 illustrates one embodiment of LED lens assembly 500. There are 4 sections, 601, 602, 603, and 604 on exterior surface 600 as shown in the window, wherein section 603 is textured with the grooving 6031. In the figure, ray 302 becomes ray 305 by total internal reflection occurred at point 401, which is further randomly reflected by the grooving structure 6031 on section 603 and becomes ray 3051. Ray 3051 later becomes the transmission ray 3052 in the air. Due to various rays 305 with different incident angles on section 603, the transmission rays 3052 behave randomly distributed in all directions such that the light distribution get broadening and smoothing.

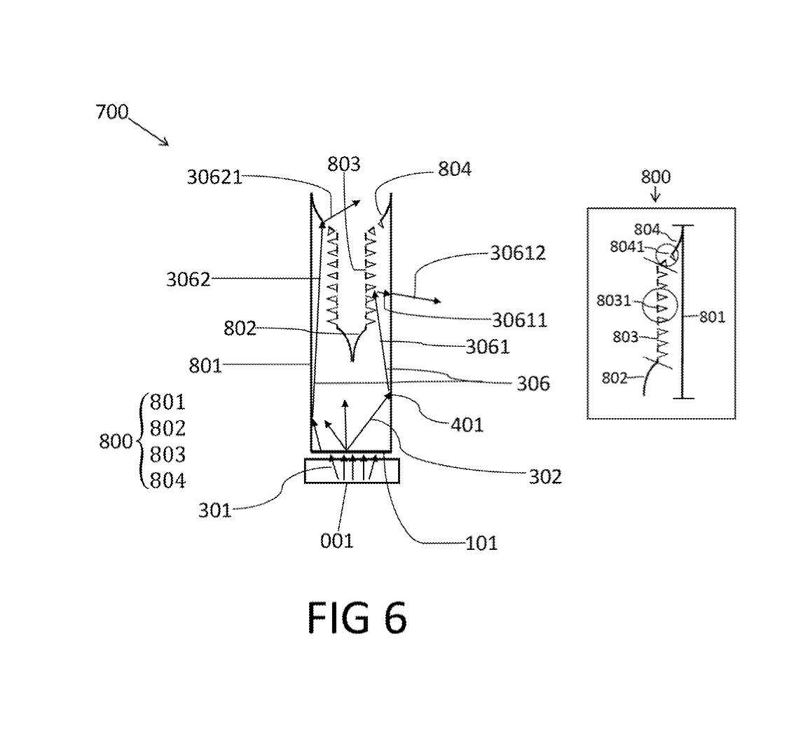

FIG. 6 shows another embodiment, the LED lens assembly 700, with broadness enhancement of light distribution similar to the embodiment of LED lens assembly 500 in FIG. 5. As indicated in the window, there are 4 sections 801, 802, 803, and 804 on exterior surface 800 in the LED lens assembly 700. Part of the bounded rays 306, say ray 3061, hits the grooving structure 8031 on surface section 803 and becomes randomly reflected ray 30611. Ray 30611 later becomes the transmitting ray 30612 in the air. Part of the bounded rays 306, say, ray 3062 propagates directly upward and reaches surface section 804. Ray 3062 passes through surface 804 and becomes the diffracted ray 30621 in the air governed by Snell's law. All exterior surface sections 801, 802, 803, 804 are free to choose different textures if necessary.

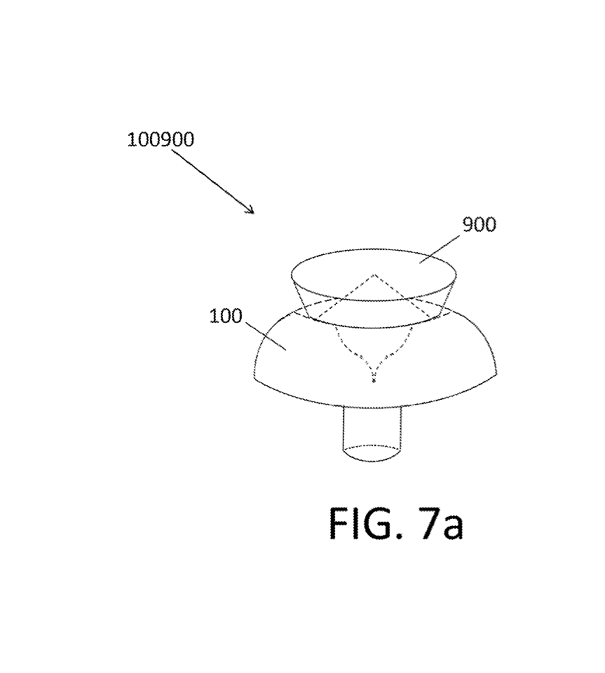

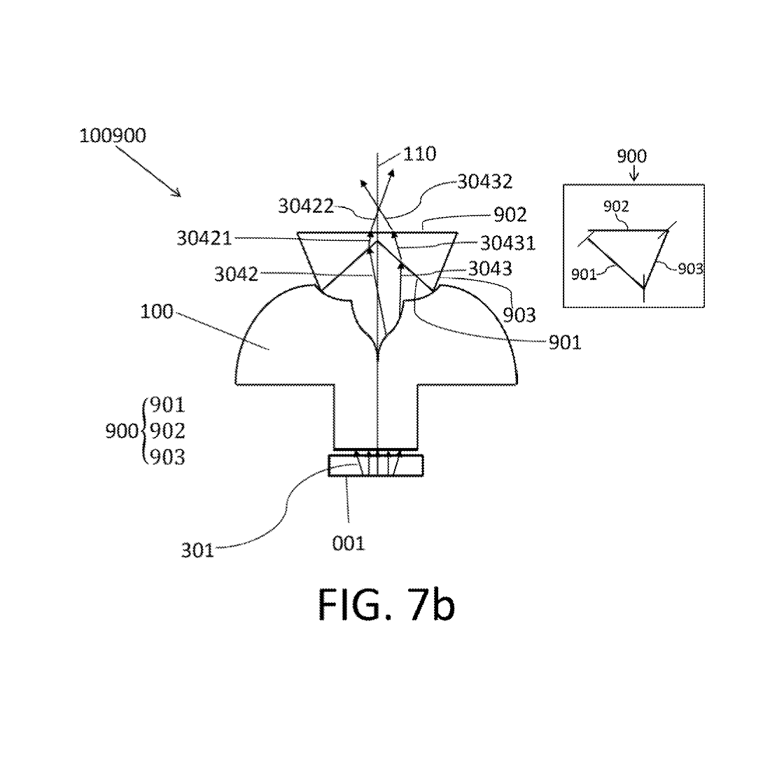

The emitting light can spread out even widely and smoothly with an additional lens attached. FIG. 7a illustrates the combination of the lens 100 in FIG. 2a with another lens 900 to form a LED lens assembly 100900. The LED lens assembly 900 is also rotationally symmetric about the longitudinal axis 110 and the surface of lens 900 is divided in 3 sections, 901, 902 and 903 as seen in the window of FIG. 7b. In FIG. 7b, ray 3042 emerging from the LED lens assembly 100 incidents on surface section 901 and becomes the diffracted ray 30421 inside the LED lens assembly 900. Ray 30421 later becomes the transmitting ray 30422 in the air with larger diffraction angle by Snell's law of diffraction. Similarly, ray 3043 will go through the same process and becomes ray 30431 inside the lens 900 and ray 30432 in the air. With attached LED lens assembly 900, light in the free space will distribute even more smoothly.

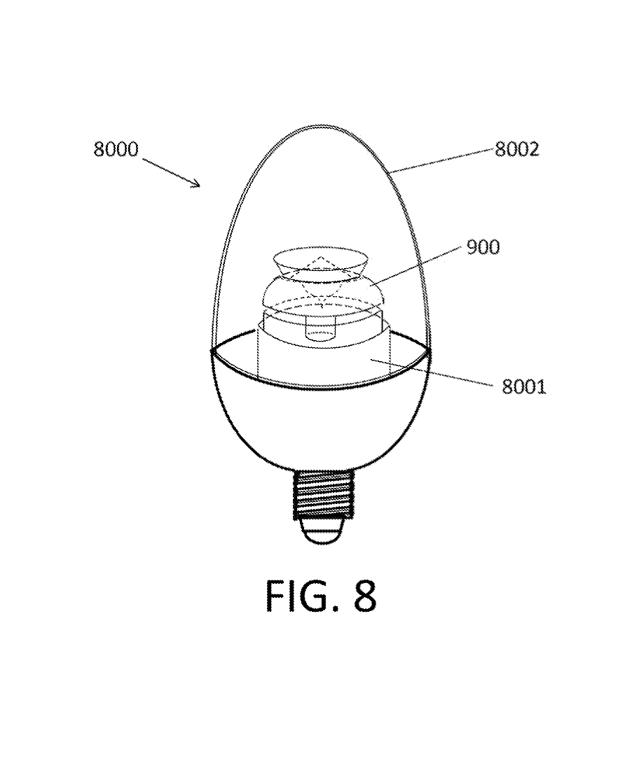

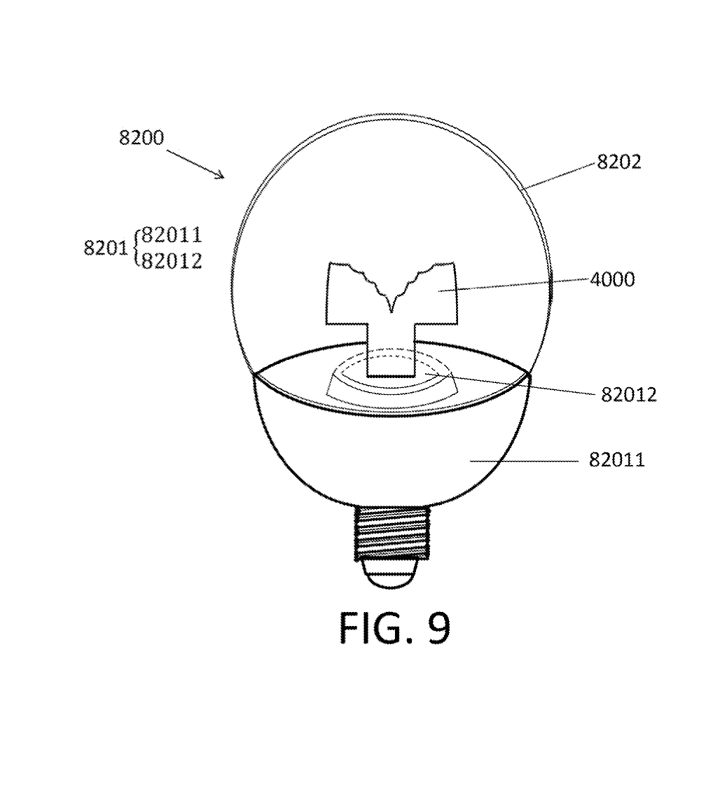

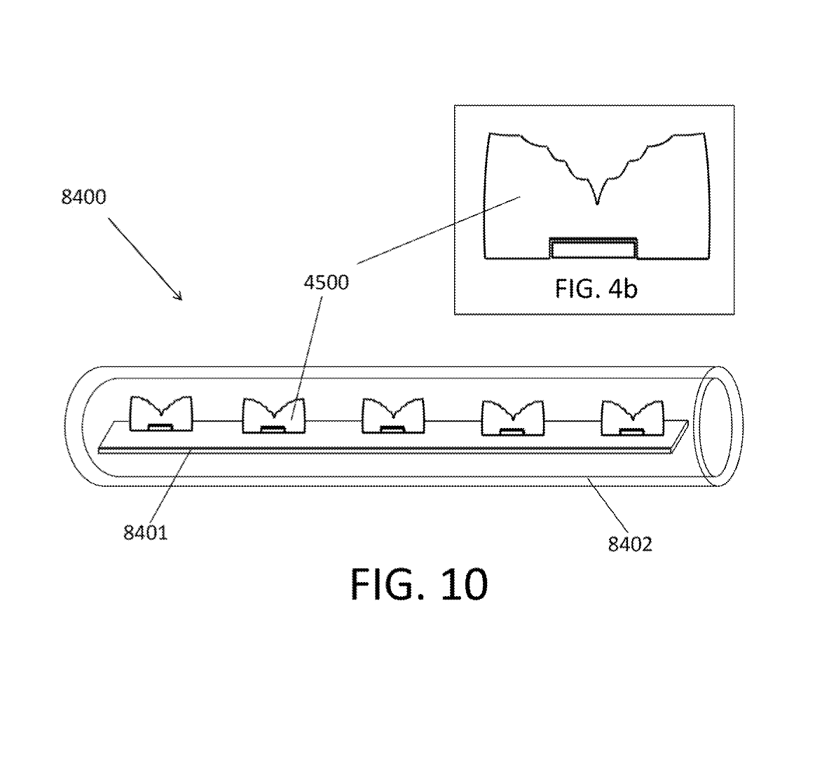

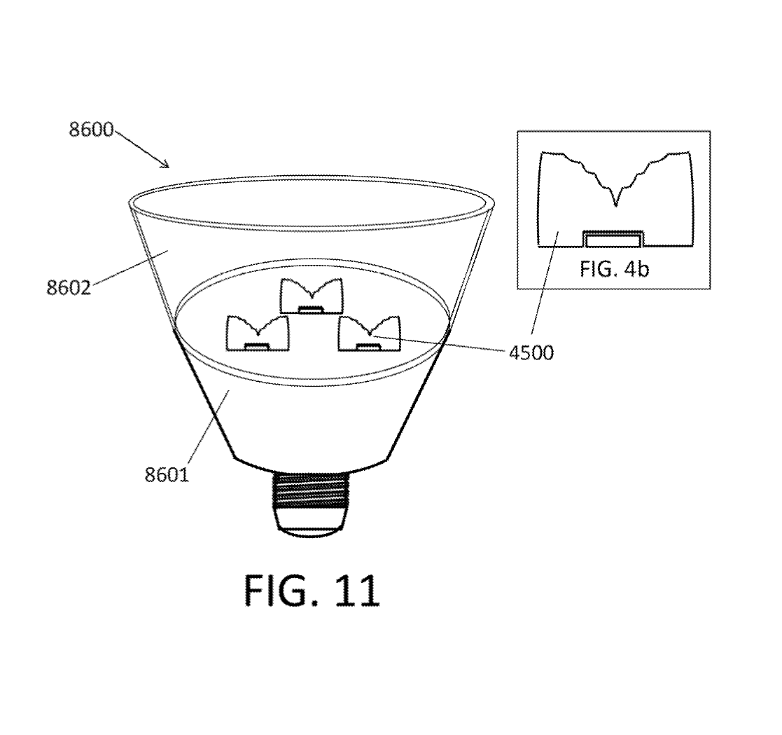

With the present invention, FIG. 8 shows a LED light bulb assembly 8000 with the LED lens assembly 100900 in FIG. 7a, one heat sink 8001, and one transparent shell 8002. FIG. 9 shows another embodiment of LED light bulb 8200 with the LED lens assembly 4000 in FIG. 4a, one heat sink 8201, and one transparent shell 8202. The heat sink 8201 includes a shape of a round cup 82011 with a lifted, flat round top surface 82012. The LED chip and lens assembly 4000 are mounted on the top surface 82012. The transparent shell 8202 covers the heat sink 8201. FIG. 10 shows one embodiment of LED tube lamp 8400 using five LED chips and LED lens assemblies 4500 in FIG. 4b. The LED lamp tube 8400 also includes one heat sink 8401 and one transparent shell 8402. The heat sink 8401 includes a shape of a long strip with a flat top surface. The LED chip and the LED lens assembly are mounted on the top surface of heat sink 8401. The transparent shell 8402 covers the heat sink 8401, Another LED round lamp 8600 is illustrated in FIG. 11. Round lamp 8600 includes three LED chips and LED lens assemblies 4500 as described in FIG. 4a, lining in one circle, one heat sink 8061 and one transparent shell 8062. The heat sink 8601 includes a shape of a round cup with a round top surface The LED chip and the LED lens assembly are mounted on the top surface of heat sink 8601. The transparent shell 8602 covers the heat sink 8601.

A number of embodiments of the present invention have been described and illustrated. Nevertheless, the scope of the invention is not intended to be limited thereby, and such other modifications, implementations and applications are particularly reserved especially as they fall within the breadth and scope of the claims here appended.

What is claimed is:

1. A LED lens assembly for broadening LED light distribution, comprising:
an inner surface for receiving a plurality of rays emitting from at least one LED chip;
an exterior surface for confining and redirecting the plurality of rays received by the inner surface;
wherein the inner surface is in contact with at least one LED chip and the inner surface is rotational symmetric about one longitudinal axis;
wherein the exterior surface is rotationally symmetric about the longitudinal axis, coaxial with the inner surface; and
wherein the exterior surface encloses the inner surface with one adjoined circular border line.

2. The LED lens assembly of claim 1, wherein the inner surface covers and touches the top surface of the LED chip closely.

3. The LED lens assembly of claim 1, wherein a longitudinal cross-section of the exterior surface containing the longitudinal axis of said rotationally symmetric exterior surface comprises a mushroom structure, a Y structure, a tree structure, a tower structure, a pillar structure, a tube structure, or a sword structure.

4. The LED lens assembly of claim 1, wherein a half of a longitudinal cross-section of the exterior surface containing the longitudinal axis of said rotationally symmetric exterior surface comprises at least three sections to constitute a periphery of the half of the longitudinal cross-section, wherein the at least three sections comprise:
at least one primary section to bound a portion of the rays received by said inner surface from said LED chip by total internal reflection with a plurality of rays propagating parallel to the longitudinal axis of said rotationally symmetric exterior surface inside the lens assembly;
at least one secondary section to receive the bounded longitudinally propagating rays from the primary section to have total internal reflection with a plurality of rays propagating transverse to the longitudinal axis of said rotationally symmetric exterior surface inside the lens assembly; and
at least one tertiary section to receive a plurality of rays reflected from the secondary section and transmit a plurality of rays into the air.

5. The LED lens assembly of claim 4, wherein said primary section transmits laterally a portion of the rays received by the inner surface from the LED chip into the air.

6. The LED lens assembly of claim 4, wherein said secondary section transmits upwardly a portion of said bounded longitudinally propagating rays from the primary section into the air.

7. The LED lens assembly of claim 4, wherein a geometric shape of each of the said three sections is selected from a group consisting of a straight line, a curve, an arc, a concave structure, and a convex structure.

8. The LED lens assembly of claim 7, wherein an arctangent of a mathematical slope of each of the said three sections is within a respective scope of:
the primary section having a tangent line at each point of a geometric shape, with the arctangent of the slope of the tangent line in the range from 45 to 135 degree;
the secondary section having a tangent line at each point of a geometric shape, with the arctangent of the slope of the tangent line in the range from 0 to 90 degree; and
the tertiary section having a tangent line at each point of a geometric shape, with the arctangent of the slope of the tangent line in the range from 0 to 180 degree.

9. The LED lens assembly of claim 4, wherein each of the said three sections has a micro structure that corresponds to at least one of a smooth surface, a diffusive surface, a grating surface, a grooving surface, a surface of random gratings, an irregular grooving surface, a random scattering surface, or a surface of photonics crystal.

10. The LED lens assembly of claim 1, farther comprising one concave lens on top of the exterior surface to form a closed region between the exterior surface and the concave lens.

11. The LED lens assembly of claim 10, wherein an index of refraction of said closed region is less than the index of refraction of the concave lens.

12. A LED light bulb comprising:
at least one LED chip;
a LED lens assembly comprising:
an inner surface for receiving a plurality of rays emitting from at least one LED chip; and
an exterior surface for confining and redirecting the plurality of rays received by the inner surface;
wherein the inner surface is in contact with at least one LED chip and is rotational symmetric about one longitudinal axis;
wherein the exterior surface is rotationally symmetric about the longitudinal axis, coaxial with the inner surface; and
wherein the exterior surface encloses the inner surface with one adjoined circular border line;
a heat sink having the LED lens assembly mounted thereon; and
a transparent shell covering the heat sink.

13. The LED light bulb of claim 12, wherein a longitudinal cross-section of the exterior surface containing the longitudinal axis of said rotationally symmetric exterior surface comprises a mushroom structure, a Y structure, a tree structure, a tower structure, a pillar structure, a tube structure, or a sword structure.

14. The LED light bulb of claim 12, wherein a half of a longitudinal cross-section of the exterior surface containing the longitudinal axis of said rotationally symmetric exterior surface comprises at least three sections to constitute a periphery of the half of the longitudinal cross-section, wherein the at least three sections comprise:
at least one primary section to hound a portion of the rays received by said inner surface from said LED chip by total internal reflection with a plurality of rays propagating parallel to the longitudinal axis of said rotationally symmetric exterior surface inside the lens assembly;
at least one secondary section to receive the bounded longitudinally propagating rays from the primary section to have total internal reflection with a plurality of rays propagating transverse to the longitudinal axis of said rotationally symmetric exterior surface inside the lens assembly; and
at least one tertiary section to receive a plurality of rays reflected from the secondary section and transmit a plurality of rays into the air.

15. A LED tube lamp comprising:
at least two LED chips lining in one row;
at least two LED lens assemblies, wherein each LED chip is covered by one of the
at least two LED lens assemblies, and each of the at least two LED lens assembly comprises:
an inner surface for receiving a plurality of rays emitting from one LED chip; and
an exterior surface for confining, and redirecting the plurality of rays received by the inner surface;
wherein the inner surface is in contact with one LED chip and is rotational symmetric about one longitudinal axis;
wherein the exterior surface is rotationally symmetric about the longitudinal axis, coaxial with the inner surface; and
wherein the exterior surface encloses the inner surface with one adjoined circular border line;
a heat sink having the LED chip and the LED lens assembly mounted thereon; and
a transparent shell covering the heat sink.

16. The LED tube lamp of claim 15, wherein a half of a longitudinal cross-section of the exterior surface containing the longitudinal axis of said rotationally symmetric exterior surface comprises at least three sections to constitute a periphery of the half of the longitudinal cross-section wherein the at least three sections comprise:
at least one primary section to bound a portion of the rays received by said inner surface from said LED chip by total internal reflection with a plurality of rays propagating parallel to the longitudinal axis of said rotationally symmetric exterior surface inside the lens assembly;
at least one secondary section to receive the bounded longitudinally propagating rays from the primary section to have total internal reflection with a plurality of rays propagating transverse to the longitudinal axis of said rotationally symmetric exterior surface inside the lens assembly; and
at least one tertiary section to receive a plurality of rays reflected from the secondary section and transmit a plurality of rays into the air.

17. A LED round lamp comprising:
at least three LED chips lining in one circle or ellipse;
at least three LED lens assemblies, wherein each LED chip is covered by one of the at least three LED lens assemblies, and each of the at least three LED lens assemblies comprises:
an inner surface for receiving a plurality of rays emitting from one LED chip; and
an exterior surface for confining and redirecting the plurality of rays received by the inner surface;
wherein the inner surface is in contact with one LED chip and is rotational symmetric about one longitudinal axis;
wherein the exterior surface is rotationally symmetric about the longitudinal axis, coaxial with the inner surface; and
wherein the exterior surface encloses the inner surface with one adjoined circular border line;
a heat sink having the LED chip and LED lens assembly mounted thereon; and
a transparent shell covering the heat sink.

18. The LED round lamp of claim 17, wherein a half of a longitudinal cross-section of the exterior surface containing the longitudinal axis of said rotationally symmetric exterior surface comprises at least three sections to constitute a periphery of the half of the longitudinal cross-section, wherein the at least three sections comprise:
at least one primary section to bound a portion of the rays received by said inner surface from said LED chip by total internal reflection with a plurality of rays propagating parallel to the longitudinal axis of said rotationally symmetric exterior surface inside the lens assembly;
at least one secondary section to receive the bounded longitudinally propagating rays from the primary section to have total internal reflection with a plurality of rays propagating transverse to the longitudinal axis of said rotationally symmetric exterior surface inside the lens assembly; and
at least one tertiary section to receive a plurality of rays reflected from the secondary section and transmit a plurality of rays into the air.
